(19) United States
(12) Patent Application Publication
(10) Pub. No.: US 2024/0206686 A1
(43) Pub. Date: Jun. 27, 2024

(54) SYSTEMS AND METHOD FOR AUTOMATIC SHOWER HEAD SHUTOFF

(71) Applicant: Walter Daguhn, Moenchengladbach (DE)

(72) Inventor: Walter Daguhn, Moenchengladbach (DE)

(21) Appl. No.: 18/146,889

(22) Filed: Dec. 27, 2022

(51) Int. Cl. A47K 3/28; B05B 1/18

(52) U.S. Cl. CPC A47K 3/281; B05B 1/185

(57) ABSTRACT

The present disclosure relates to systems and methods for automatic shutoff of a handheld shower head. In one embodiment, a shower system includes a shower head and a shutoff device arranged along a flow path of water to the shower head configured to control a flow of water to the shower head based on a position of the shower head. The shower system may further include a mount shaped to receive the shower head, where seating the shower head within the mount actuates the shutoff device to maintain a flow rate of water from the shower head below a pre-determined threshold flow rate.

### TECHNICAL FIELD

The present disclosure relates to a shower system including an automatic shower head shutoff device and a method for operating the shower system.

### BACKGROUND

Shower systems often include a handheld shower head to provide the user with additional flexibility to control the direction of water flow. Such handheld shower heads may be stored via a shower head cradle, in some examples, and may be removed from the shower head cradle when additional control of the direction of water flow is desired. Often, the flow of water to the shower head is controlled via a flow diverter and a valve operated by the user, where the valve may be opened by the user to direct the flow of water away from a faucet and/or stationary shower head and into the handheld shower head. In order to return the flow of water to the faucet and/or stationary shower head, the user may close the valve, which results in stopping the flow of water to the handheld shower head. It may be desirable to stop the flow of water from the handheld shower head prior to, or during, the storing of the shower head via the cradle to reduce a likelihood of undesired spraying of water toward the cradle and/or other surfaces and to reduce water usage. However, during some conditions it may be difficult for the user to operate the valve, for example, while the user is holding the handheld shower head in one hand and another item in the other hand. Further, during conditions in which the shower system is used for an extended duration without flowing water from the handheld shower head, a temperature of the handheld shower head may decrease below a comfortable temperature.

Therefore, it is the object of the present disclosure to provide a shower system that increases user comfort, reduces a likelihood of undesired flow of water from the shower head, and reduces water usage.

### SUMMARY

According to the present disclosure, a shower system includes a shower head and a shutoff device arranged along a flow path of water to the shower head. The shutoff device is configured to control a flow of water to the shower head based on a position of the shower head. The shower system may further include a mount shaped to receive the shower head, and seating the shower head within the mount actuates the shutoff device to maintain a flow rate of water from the shower head below a pre-determined threshold flow rate.

According to an embodiment, a shower system includes a mount, a shower head shaped to seat within the mount, and a shutoff device engaged by seating the shower head within the mount. While the shutoff device is engaged, the shutoff device restricts a flow of water from the shower head. The shutoff device may be arranged upstream of each of the mount and the shower head, or integrated with one of the mount or the shower head.

According to an embodiment, a method for a shower system includes controlling a flow rate of water from a shower head based on a position of the shower head by adjusting engagement of a shutoff device automatically responsive to the position of the shower head. Engaging the shutoff device may maintain the flow rate of water from the shower head below a pre-determined threshold flow rate.

### BRIEF DESCRIPTION OF THE FIGURES

The present disclosure will be explained hereinafter in more detail making reference to the following figures:

FIG. 1 schematically shows a shower system including a shutoff device according to the present disclosure.

FIG. 2 shows a side view of a shower system including a shutoff device with a shower head in a first position, according to an embodiment of the present disclosure.

FIG. 3 shows another side view of the shower system of FIG. 2, with the shower head in a second position.

FIG. 4 shows another side view of the shower system of FIGS. 2-3, with the shower head in a third position.

FIG. 5 shows another side view of the shower system of FIGS. 2-4, with the shower head in a fourth position.

FIG. 6 shows an enlarged side view of the shower system of FIGS. 2-5.

FIG. 7 shows a flow chart illustrating a method for controlling a flow rate of water from a shower head of a shower system including a shutoff device, according to an embodiment of the present disclosure.

### DETAILED DESCRIPTION

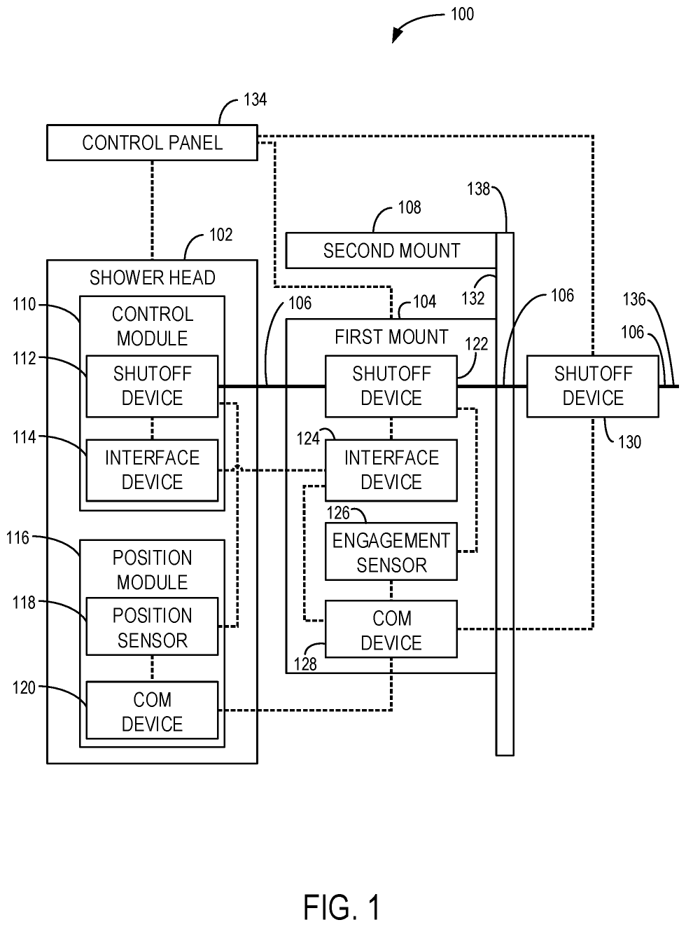

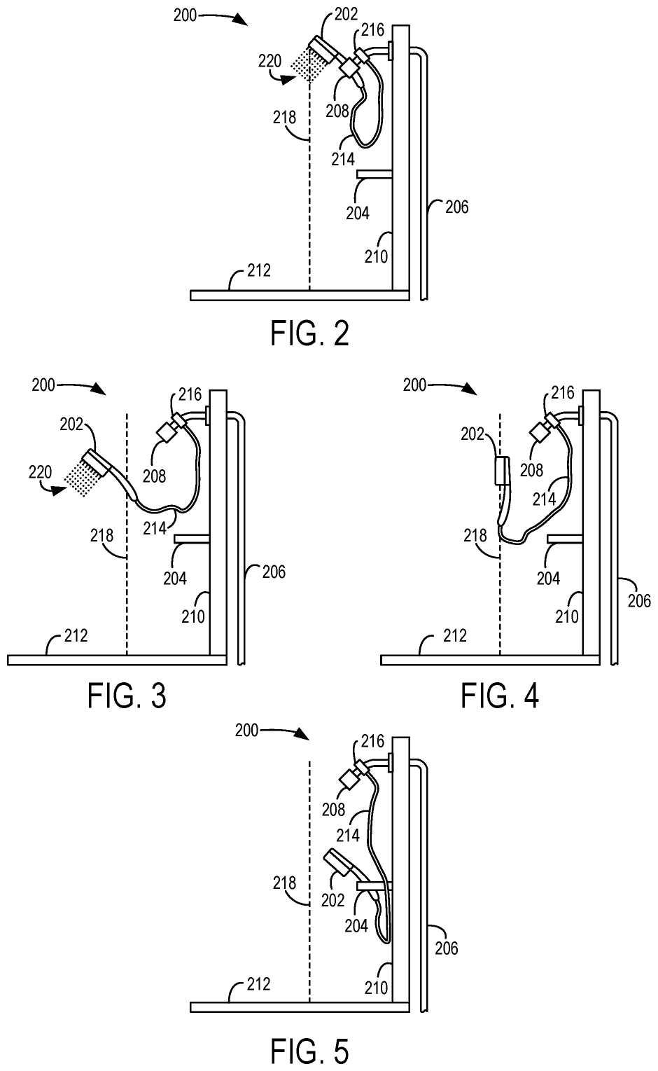

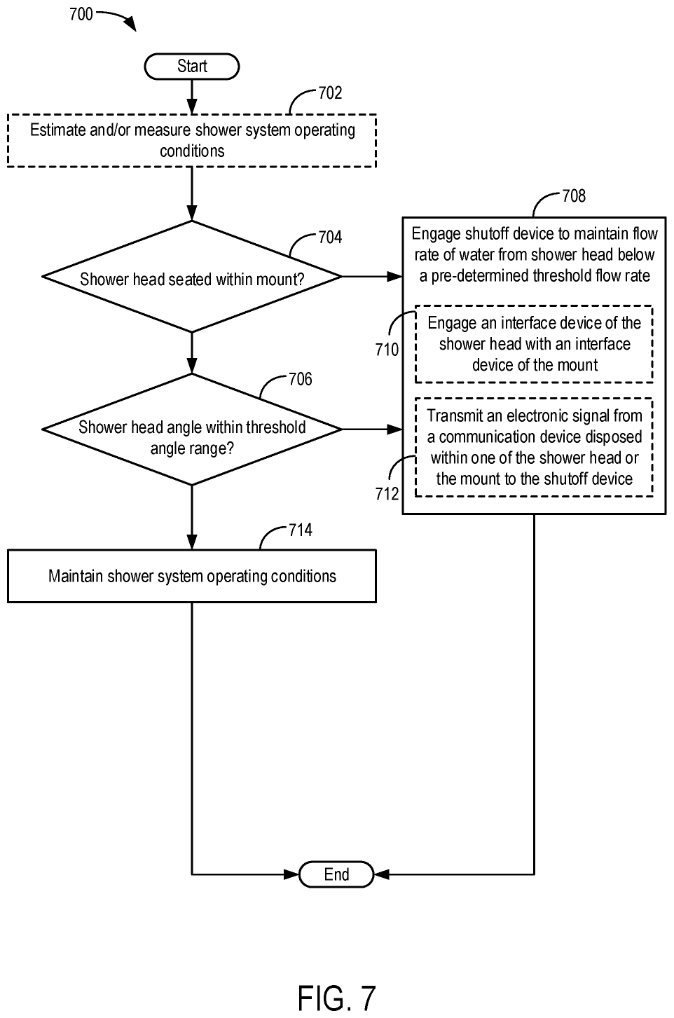

The following description relates to shower systems including a handheld shower head with an automatic shutoff device and methods for operating the same. A shower system, such as the shower system shown by FIG. 1, includes a handheld shower head, such as the handheld shower head shown by FIGS. 2-6. The shower system is configured such that the flow of water from the handheld shower head is automatically reduced to a drip or stopped altogether during conditions in which the handheld shower head is seated within a mount and/or during conditions in which an angle of the handheld shower head is within a pre-determined angle range, for example, as shown by the flow chart of FIG. 7. As a result, user comfort may be increased, water consumption may be reduced, and an ease of maintaining a temperature of a water flow from the handheld shower head may be increased.

A shutoff device as used herein, thus, may also be referred to as a flow-reduction device. The flow of water to the handheld shower head may be controlled thereby such as to stop completely or to be reduced to a level below a pre-determined threshold flow rate. The pre-determined threshold flow rate may be lower than the flow rate of the handheld shower head prior to actuating the shutoff device, in particular at least 50%, more particularly at least 90% lower. In other words, when the shutoff device is actuated, less or no water is output by the handheld shower head. The shutoff device may be particularly configured to provide an automatic reducing of the flow rate of water from the handheld shower head below the pre-determined threshold flow rate during conditions in which a predetermined shutoff condition is satisfied. Examples for the predetermined shutoff conditions will be discussed below.

The reduced flow rate may be maintained until the predetermined shutoff condition is no longer satisfied. In other words, the shutoff device may be particularly configured to provide an automatic increase of the flow rate of water from the handheld shower head to a previously set amount during conditions in which a predetermined shutoff condition is no longer satisfied.

The shutoff device being arranged along a flow path of water to the shower head may particularly mean that the shutoff device may be arranged upstream of the handheld shower head or within the shower head itself. The shutoff device may particularly comprise a valve, in particular a control valve such as a solenoid valve.

The handheld shower head may be coupled to a water supply line, in particular via a flexible hose. The handheld shower head may be positionable in a mount. When seated in the mount, the shower head may be held in a predetermined position. The predetermined position may be a fixed position or a variable or adjustable position.

Referring to FIG. 1, a shower system 100 including a handheld shower head 102 is schematically shown. The shower system 100 may be included within a lavatory, for example. The handheld shower head 102, which may be referred to herein simply as the shower head 102, may be held by a user of the shower system 100 in order to direct a flow of water from the shower head 102 as desired by the user. For example, the shower head 102 may be held by the user and rotated, pivoted, etc. as water flows from the shower head 102 in order to adjust the direction of the flow of the water from the shower head 102 (e.g., during bathing, to direct water toward particular anatomy of the user).

The shower head 102 is fluidly coupled to a water supply 106 and is configured to receive water from the water supply 106.

The water supply 106 illustrates a water flow path to the shower head 102. The water supply 106 may include a water supply line infrastructure 136 included within the environment of the shower system 100. For example, the water supply line infrastructure 136 may be a water supply pipe arranged behind and/or within a wall 138 of the lavatory including the shower system 100.

The shower system 100 includes one or more shutoff devices, such as shutoff device 112 included by shower head 102, shutoff device 122 included by first mount 104, and/or shutoff device 130 arranged behind and/or within the wall 138 and fluidly coupled to the water supply line infrastructure 136. Although FIG. 1 shows three shutoff devices (e.g., shutoff device 112, shutoff device 122, and shutoff device 130), in some embodiments the shower system 100 may include fewer or even more shutoff devices, in particular a single shutoff device. For example, in one embodiment, the shower system 100 may include the shutoff device 112 and may not include the shutoff device 122 and/or the shutoff device 130. In another embodiment, the shower system 100 may include the shutoff device 122 and may not include the shutoff device 112 and/or the shutoff device 130. In yet another embodiment, the shower system 100 may include the shutoff device 130 and may not include the shutoff device 112 and/or the shutoff device 122. Each shutoff device may be a valve (e.g., solenoid valve), in some examples.

Each shutoff device may be engaged to slow (e.g., restrict) and/or stop a flow of water to the shower head 102. For example, in one embodiment, the shower system 100 includes the shutoff device 112 arranged within the shower head 102, and the shutoff device 112 may be engaged to slow and/or stop the flow of water to the shower head 102. As a result, a flow of water from the shower head 102 similarly slowed and/or stopped. Engagement of one or more of the shutoff devices may be based on a position of the shower head 102, as described further below.

In one embodiment, the shower head 102 includes a control module 110, where the control module 110 is a portion of the shower head 102 including the shutoff device 112 and an interface device 114. Further, the first mount 104 includes an interface device 124 that may engage with the interface device 114 of the shower head 102 during conditions in which the shower head 102 is seated within the first mount 104. In some examples, the interface device 114 and interface device 124 may be mechanical devices shaped to engage with each other (e.g., mesh with each other, fit within one another, etc.).

As one example, the interface device 124 of the first mount 104 may be a switch or toggle, and the interface device 114 of the shower head 102 may be a protrusion or other surface feature shaped to actuate the interface device 124 of the first mount 104 during conditions in which the shower head 102 is seated within the first mount 104. Although the interface device 124 of the first mount 104 is described as being a switch or toggle, other configurations are possible.

In some examples, at least one of the interface device 114 or the interface device 124 may be a magnet. For example, the interface device 124 of the mount 104 may be a magnet configured to engage electromechanically with the interface device 114 of the shower head 102. In another example in which interface device 124 is a magnet or includes a magnet, force may be applied by the interface device 124 against the interface device 114 via a magnetic field generated by the magnet (e.g., force may be applied to the interface device 114 by the interface device 124 via the magnetic field, with or without a direct mechanical connection between the interface device 114 and the interface device 124).

Engagement of the interface device 114 with the interface device 124 actuates the shutoff device 112 arranged within the shower head 102 in order to engage the shutoff device 112 and slow and/or stop the flow of water from the shower head 102. In an example operation, a user of the shower system 100 may place the shower head 102 within the first mount 104 (e.g., seat shower head 102 within the first mount 104), and as a result, the interface device 114 of the shower head 102 may engage with the interface device 124 of the first mount 104. The engagement of the interface devices actuates the shutoff device 112, and the flow of water from the shower head 102 is slowed and/or stopped. The shower head 102 therefore transitions from a condition in which water flows from the shower head 102 (e.g., flows at a rate suitable for washing, bathing, etc.) while the shower head 102 is unseated from the mount 104, to a condition in which water does not flow from the shower head 102 or flows at a rate that is substantially zero (e.g., drips at a rate low enough to maintain a temperature of water at the shower head 102 without spraying from the shower head 102) while the shower head 102 is seated within the mount 104. By controlling the flow of water from the shower head 102 based on the position of the shower head 102 as described above, user comfort may be increased, and water usage (e.g., consumption) may be reduced. For example, water usage may be reduced by approximately 30% relative to shower systems that do not include the configurations described herein by automatically reducing the flow rate of water from the shower head 102 as described herein.

In another embodiment, the shower head 102 includes the interface device 114 and does not include the shutoff device 112, while the first mount 104 includes the interface device 124 and includes the shutoff device 122. During conditions in which the shower head 102 is seated within the first mount 104, the interface device 114 of the shower head 102 may engage with the interface device 124 of the first mount 104 as described above, and as a result, the shutoff device 122 within the first mount 104 may be actuated in order to slow and/or stop the flow of water from the shower head 102 as described above. For example, the water supply 106 may extend through the first mount 104, and water may flow from the first mount 104 to the shower head 102 via a hose or other connection. During conditions in which the shutoff device 122 is engaged, the flow of water from the first mount 104 to the shower head 102 may be slowed and/or stopped, such that the flow of water from the shower head 102 is similarly slowed and/or stopped. As described further below, the flow of water from the shower head 102 during conditions in which one of the shutoff devices described herein is engaged may be maintained below a pre-determined threshold flow rate, such as a low flow rate that maintains a temperature of water at the shower head 102 without resulting in spraying of the water from the shower head 102. The pre-determined threshold flow rate may be a flow rate sufficiently small to provide dripping of water from the shower head 102. By maintaining the flow rate of water from the shower head 102 below the pre-determined threshold flow rate, water may drip from the shower head 102 and a temperature of the shower head 102 may be maintained by the drip of water from the shower head 102. For example, the flow rate of water from the shower head 102 resulting in the dripping of water from the shower head 102 may be sufficient to ensure that the temperature of water output by the shower head 102 does not decrease below a threshold temperature, where the threshold temperature may be set (e.g., selected) by the user of the shower head 102 (e.g., via user input to control panel 134 and/or via user adjustment of one or more water flow valves of the shower system 100). The drip of water may further serve as a reminder to the user to turn off the water supply to the shower head 102 (e.g., close a manually-operated faucet or valve of the shower system) following completion of the use of the shower system 100 by the user.

In yet another embodiment, the shower head 102 includes the interface device 114 and the first mount 104 includes the interface device 124. As described above, the first mount 104 may receive the water supply 106 and may flow water to the shower head 102 via a hose. The hose may include a shutoff device similar to the shutoff device 112 and/or the shutoff device 122 described above, and engagement of the interface device 114 with the interface device 124 may actuate the shutoff device included by the hose in order to slow and/or stop the flow of water from the shower head 102 during conditions in which the shower head 102 is seated within the first mount 104.

In some embodiments, the shower head 102 may include a position module 116. The position module may include a position sensor 118 configured to sense (e.g., measure, detect, etc.) a position (e.g., orientation) of the shower head 102. The position sensor 118 may be an electronic position sensor, in some examples. In other examples, the position sensor 118 may be mechanically operated via gravity. The position sensor 118 may sense a position of the shower head 102 relative to a direction of gravity, and during conditions in which the shower head 102 is oriented vertically (e.g., parallel to the direction of gravity), the position sensor 118 may interact with the shutoff device 112 (e.g., transmit electronic signals to the shutoff device 112, mechanically actuate the shutoff device 112, etc.) in order to engage the shutoff device 112 to slow and/or stop the flow of water to the shower head 102, similar to the examples described above. The position sensor 118 may interact with the shutoff device 112 in order to engage the shutoff device 112 during conditions in which an angle of the shower head 102 relative to the direction of gravity is within a threshold angle range. For example, during conditions in which the shower head 102 is oriented substantially vertically such that the shower head 102 extends between -10 degrees and 10 degrees relative to the direction of gravity, the position sensor 118 may interact with the shutoff device 112 to engage the shutoff device 112. In some configurations, during conditions in which the shower head 102 is seated within the first mount 104, the position of the shower head 102 may be substantially vertical such that the angle of the shower head is within the threshold angle range, resulting in engagement of the shutoff device 112. As a result, during conditions in which the shower head 102 is seated within the first mount 104, the flow of water from the shower head 102 is stopped and/or slowed to a drip by the shutoff device 112.

In some examples, the position sensor 118 may sense a rotation of the shower head 102 in other directions. For example, the position sensor 118 may be configured such that during conditions in which the shower head 102 faces in a forward direction (e.g., a direction away from the wall 138 and approximately normal to the wall 138), the position sensor 118 may sense that the shower head 102 is oriented in the forward direction and may maintain the shutoff device 112 in a disengaged condition. However, during conditions in which the shower head 102 is rotated away from the forward direction (e.g., rotated in a left and/or right direction around an axis parallel with the direction of gravity and/or a longitudinal axis of the shower head 102), the position sensor 118 may sense that the shower head 102 is not facing in the forward direction and may engage the shutoff device 112 to stop the flow of water from the shower head 102 or slow the flow of water from the shower head 102 to a drip. The position sensor 118 may interact with the shutoff device 112 to engage the shutoff device 112 during conditions in which the rotation of the shower head 102 in the left direction or right direction exceeds a threshold amount of rotation away from the forward direction (e.g., forward orientation). For example, the shower head 102 may be normally oriented in the forward direction (e.g., forward orientation) to flow water in a direction away from the wall 138. During conditions in which the shower head 102 is rotated away from the forward direction by an amount greater than a threshold amount (e.g., 90 degrees), the position sensor 118 may interact with the shutoff device 112 to engage the shutoff device 112. In this way, a likelihood of water spraying from the shower head 102 toward the wall 138 may be reduced.

In another embodiment, the position module 116 of the shower head 102 may include a communication device 120. The communication device 120 may be a wireless communication device configured to transmit and/or receive wireless electronic signals, in some examples. The communication device 120 may receive signals (e.g., electronic signals) from the position sensor 118 and may communicate the position (e.g., orientation, angle, etc.) of the shower head 102 to devices arranged externally to the shower head 102. For example, the first mount 104 may include a communication device 128 in electronic communication with the communication device 120 of the shower head 102. The communication device 128 may be configured to send and/or receive electronic signals to/from the communication device 120. The communication device 128 may be in communication (e.g., electronic communication, optical communication, mechanical communication, etc.) with shutoff device 122 arranged within the first mount 104, in some embodiments, and during conditions in which the position sensor 118 senses that the angle of the shower head 102 is within the threshold angle range, the position sensor 118 transmits position information to the communication device 120, and the communication device 120 transmits the position information to communication device 128. The communication device 128 then communicates electronically with the shutoff device 122 in order to engage the shutoff device 122.

In some embodiments, the communication device 120 and/or the communication device 128 may communicate (e.g., electronically, optically, mechanically, etc.) with shutoff device 130 arranged external to each of the shower head 102 and the first mount 104. The shutoff device 130 may be engaged responsive to signals received by the shutoff device 130 from one of the communication device 120 and/or the communication device 128. As one example, communication device 128 may be configured to detect (e.g., sense, measure, etc.) a condition of interface device 124 (e.g., detect whether interface device 124 is engaged with, or disengaged from, interface device 114). During conditions in which the interface device 124 is engaged with the interface device 114, the communication device 128 may communicate with the shutoff device 130 in order to actuate the shutoff device 130 to reduce (and maintain) the flow rate of water from the shower head 102 below the pre-determined threshold flow rate. Communication between the communication device 128 and the shutoff device 130 may be electronic communication (e.g., wireless electronic communication, and/or communication via a direct electrical connection between the communication device 128 and the shutoff device 130), optical communication (e.g., via one or more optical sensors, mirrors, light-emission features, etc.), or the like, in some examples. The communication device 128 may detect the condition of interface device 124 mechanically (e.g., via a mechanical coupling of the interface device 124 to the communication device 128), electronically (e.g., via a wireless and/or wired electronic connection between the interface device 124 and the communication device 128), optically (e.g., via one or more optical sensors, mirrors, light-emission features, etc. of the communication device 128 and/or interface device 124), etc., in some embodiments. For example, during conditions in which the interface device 124 is engaged with the interface device 114, the interface device 124 may press against a sensor of the communication device 128 or otherwise interact with sensing element of the communication device 128, and as a result the communication device 128 may determine that the interface device 124 is engaged with the interface device 114. The communication device 128 may then communicate with the shutoff device 130 to reduce (and maintain) the flow rate of the water from the shower head 102 below the pre-determined threshold flow rate.

In another embodiment, the first mount 104 may include an engagement sensor 126 configured to detect engagement of the shower head 102 with the first mount 104 (e.g., detect the seating of the shower head 102 within the first mount 104). During conditions in which the engagement sensor 126 detects that the shower head 102 is seated within the first mount 104, the engagement sensor 126 may communicate with the shutoff device 122 (e.g., communicate electronically) in order to engage the shutoff device 122 to slow and/or stop the flow water from the shower head 102.

Although in some embodiments the devices described above may communicate with each other wirelessly, in other embodiments the devices may communicate in a different way. For example, the communication device 120 within the first mount 104 may have a direct electrical connection to the shutoff device 130 and/or shutoff device 122 and may communicate electronically with the shutoff devices via the direct electrical connection. As another example, engagement sensor 126 may be an optical sensor that may have a direct electrical connection to the shutoff device 122 arranged within the first mount 104, and the engagement sensor 126 may communicate electronically with the shutoff device 122 via the direct electrical connection. Other examples are possible.

The shower system 100 may additionally include a control panel 134 in electronic communication with the shower head 102 and/or the first mount 104. During conditions in which the flow of water to the shower head 102 is slowed and/or stopped by a shutoff device (e.g., shutoff device 112, shutoff device 122, etc.), an indicator of the control panel 134 (e.g., an indicator light, such as an LED) may change condition (e.g., illuminate) to indicate that the flow of water is slowed and/or stopped. In some examples, the user may interact with the control panel 134 in order to engage a shutoff device to slow and/or stop the flow of water to the shower head 102, such as the shutoff device 130 described above.

In some embodiments, the shower system 100 includes a second mount 108. The shower head 102 may be seated within the second mount 108 without engagement of the shutoff devices described above. For example, during some conditions, the user may desire to maintain the flow rate of water from the shower head 102 at a rate suitable for washing and/or bathing (e.g., 2.5 gallons per minute (9.5 liter per minute)) without holding the shower head 102 in the users hands. By seating the shower head 102 within the second mount 108, the shower head 102 may be operated in the hands-free mode wherein water flows from the shower head 102 while the position of the shower head 102 is maintained by the second mount 108, without engagement of the shutoff devices described above. Each of the first mount 104 and the second mount 108 may be coupled to a same surface 132. In one example, the surface 132 is a surface of the wall 138. In another example, the surface 132 may be a bar or other structure coupled to the wall 138. In some examples, the first mount 104 and the second mount 108 may be formed together as a single, unitary piece, with the first mount 104 configured to shutoff the flow of water to the shower head 102 during conditions in which the shower head 102 is seated within the first mount 104, and with the second mount 108 configured to not shutoff the flow of water to the shower head 102 during conditions in which the shower head 102 is seated within the second mount 108.

In some embodiments, the shower head 102 includes shutoff device 112, where shutoff device 112 may be arranged within a housing (e.g., casing) of the shower head 102 and/or fixed to an exterior of the shower head 102. The shutoff device 112 may control the flow of water from the shower head 102 and may operate independently of shutoff device 122 and shutoff device 130. As one example, the shower system 100 may include the shutoff device 112 arranged within the shower head 102 and/or fixed to the shower head 102 and may not include the shutoff device 122 and the shutoff device 130. The shower head 102 may thus be a single unit, including the shutoff device 112, configured to provide the automatic reducing of the flow rate of water from the shower head 102 below the pre-determined threshold flow rate during conditions in which a shutoff condition is satisfied. The shutoff condition may be, for example, a condition in which the shower head 102 is seated within the first mount 104, as described above. The interface device 114 of the shower head 102 (which may be arranged within the housing of the shower head 102 or fixed to the exterior of the shower head 102) may engage (e.g., mesh) with the interface device 124 of the first mount 104, and as a result, the shutoff device 112 may reduce the flow rate of water from the shower head 102 below the pre-determined threshold flow rate (and maintain the flow rate below the threshold flow rate while the shower head 102 is seated within the first mount 104).

In some embodiments, the shower head 102 may include the shutoff device 112 and the interface device 114 and may not include the position module 116, position sensor 118, and/or communication device 120, the first mount 104 may include the interface device 124 and may not include the shutoff device 122, the engagement sensor 126, and/or the communication device 128, and the shutoff device 130 may be omitted. Thus, shutoff device 112 may be included with the shower head 102 and the shower system may not include the shutoff device 122 and the shutoff device 130, in some embodiments.

In some examples, the interface device 114 may include an opening (e.g., passage, channel, groove, etc.) formed in the housing of the shower head 102, and the interface device 124 may include a protrusion (e.g., extension, arm, knob, etc.) formed at an exterior surface of the first mount 104. The protrusion of the interface device 124 may be shaped to insert into the opening of the interface device 114, and during conditions in which the protrusion is inserted into the opening, the interface device 124 engages with the interface device 114. The engagement of the interface device 124 with the interface device 114 may actuate the shutoff device 112, and as a result, the shutoff device 112 may reduce (and maintain) the flow rate of water from the shower head 102 below the pre-determined threshold flow rate. As one example, the protrusion of the interface device 124 may press against the shutoff device 112 via insertion of the protrusion into the opening of the interface device 114, and the pressing of the protrusion against the shutoff device 112 may actuate the shutoff device 112 as described above. In other examples, the interface device 114 may include a different structure (e.g., a button, gear, etc.) shaped to engage with a counterpart structure (e.g., bump, counterpart gear, etc., respectively) of the interface device 124, and engaging the interface device 124 with the interface device 114 may cause the interface device 114 to actuate the shutoff device 112 to reduce (and maintain) the flow rate of water from the shower head 102 below the pre-determined threshold flow rate as described above.

In the configurations described above (e.g., wherein the shower head 102 includes the shutoff device 112), the shower head 102 and first mount 104 may be retrofitted to other shower systems in order to provide the automatic shutoff of the flow of water from the shower head 102 via the shutoff device 112 (e.g., the reduction and maintenance of the flow rate of water from the shower head 102 below the pre- determined threshold flow rate responsive to satisfaction of a shutoff condition, such as engagement of the interface device 114 of the shower head 102 with the interface device 124 of the first mount 104).

Referring collectively to FIGS. 2-5, various side views of a shower system 200 are shown. The shower system 200 may be similar to, or the same as, the shower system 100 shown by FIG. 1 and described above. Further, several of the components included by the shower system 200 may be similar to, or the same as, the components described above with reference to shower system 100 shown by FIG. 1. For example, the shower system 200 includes a shower head 202 and a first mount 204, which may be similar to, or the same as, the shower head 102 and first mount 104, respectively, described above with reference to FIG. 1. In the example shown, the shower system 200 additionally includes a second mount 208, which may be similar to, or the same as, the second mount 108 described above with reference to FIG. 1.

FIG. 2 shows a side view of the shower system 200 with the shower head 202 seated within the second mount 208, FIG. 3 shows a side view of the shower system 200 with the shower head 202 decoupled (e.g., unseated) from the second mount 208, FIG. 4 shows a side view of the shower system 200 with the shower head 202 rotated to a vertical orientation, and FIG. 5 shows a side view of the shower system 200 with the shower head 202 seated within the first mount 104.

In the view shown by FIGS. 2-5, the ground surface 212 is shown, along with a wall 210. The wall 210 may be a wall of an environment of the shower system 200, such as a lavatory. A water supply line 206 fluidly couples to the shower head 202 through the wall 210. The water supply line 206 may be a water pipe or other water delivery infrastructure included within the environment of the shower system 200. Axis 218 is provided to indicate the direction of gravity (e.g., the vertical direction), with the axis 218 being normal to the ground surface 212.

In the example shown, the shower head 202 may receive water from the water supply line 206 via a hose 214, where the hose 214 fluidly couples to the water supply line 206 via a connector 216 arranged at the second mount 208. In other embodiments, however, the connector 216 may be arranged at the first mount 204, such that water flows from the water supply line 206 to the shower head 202 via the first mount 204 including the connector 216. The water supply line 206 may be similar to, or the same as, the water supply line infrastructure 136 described above with reference to FIG. 1.

Similar to the examples described above, during conditions in which the shower head 202 is seated within the first mount 204, the flow of water from the shower head 202 is slowed and/or stopped by a shutoff device, such as the shutoff device 112, the shutoff device 122, or the shutoff device 130 described above with reference to FIG.

1. However, during conditions in which the shower head 202 is seated within the second mount 208, the flow of water from the shower head 202 is not slowed and/or stopped by a shutoff device. In the view shown by FIG. 2, the shower head 202 is seated within the second mount 208, and water flows from the shower head 202 as indicated by water spray 220. In this configuration, the water flows from the shower head 202 without the shower head 202 being held by the user of the shower system 200, such that the user may bathe hands-free (e.g., without holding the shower head 202).

In the view shown by FIG. 3, the shower head 202 is removed from the second mount 208 and is not seated within either of the second mount 208 or the first mount 204. In this configuration, water continues to flow from the shower head 202, as conditions that may engage the shutoff devices similar to those described above with reference to FIG. 1 have not been satisfied. In particular, because the shower head 202 is not seated within the first mount 204, a shutoff device within the shower head 202 (e.g., similar to shutoff device 112 described above with reference to FIG. 1) or a shutoff device within the first mount 204 (e.g., similar to shutoff device 122 described above with reference to FIG. 1) is not engaged. Further, in some configurations, the shower head 202 may include a position sensors similar to, or the same as, the position sensor 118 described above with reference to FIG. 1. However, because an angle of the shower head 202 in the configuration shown by FIG. 3 is not within a threshold angle range relative to the vertical direction (e.g., relative to axis 218), the position sensor does not interact with a shutoff device to engage the shutoff device to stop and/or slow the flow of water from the shower head 202.

In the view shown by FIG. 4, the shower head 202 is not seated within either of the second mount 208 or the first mount 204. However, the shower head is rotated to a position that is approximately vertical (e.g., parallel with the axis 218), and in the configuration shown, the shower head 202 includes the position sensors described above.

As a result, the position sensor communicates with a shutoff device, such as one of the shutoff devices described above, to slow and/or stop the flow of water from the shower head 202. In some embodiments however, the shower system may not include the position sensor, and rotating the shower head 202 to the position that is approximately vertical may not result in the slowing and/or stopping of the flow of water from the shower head 202.

The view shown by FIG. 5, the shower head 202 is seated within the first mount 204, and as a result, the flow of water from the shower head 202 is slowed and/or stopped. For example, the shower head 202 may include an interface device (e.g., similar to, or the same as, the interface device 114 described above with reference to FIG. 1) and the first mount 204 may include a counterpart interface device (e.g., similar to, or the same as, the interface device 124 described above with reference to FIG. 1). The interface devices may engage with each other during conditions in which the shower head 202 is seated within the first mount 204, and as a result, the flow of water from the shower head 202 may be slowed and/or stopped (e.g., via a shutoff device disposed within the shower head, such as shutoff device 112 shown by FIG. 1, or a shutoff device disposed within the first mount 204, such as the shutoff device 122 shown by FIG. 1). As another example, the second mount 204 may include an engagement sensor configured to sense the seating of the shower head 202 within the second mount 204, such as the engagement sensor 126 shown by FIG. 1 and described above. Engagement sensor may communicate with a shutoff device, such as a shutoff device coupled to the water supply line 206 (e.g., similar to, or the same as, the shutoff device 130 shown by FIG. 1 and described above) or a shutoff device included by the first mount 204 to slow and/or stop the flow of water from the shower head 202 via the shutoff device.

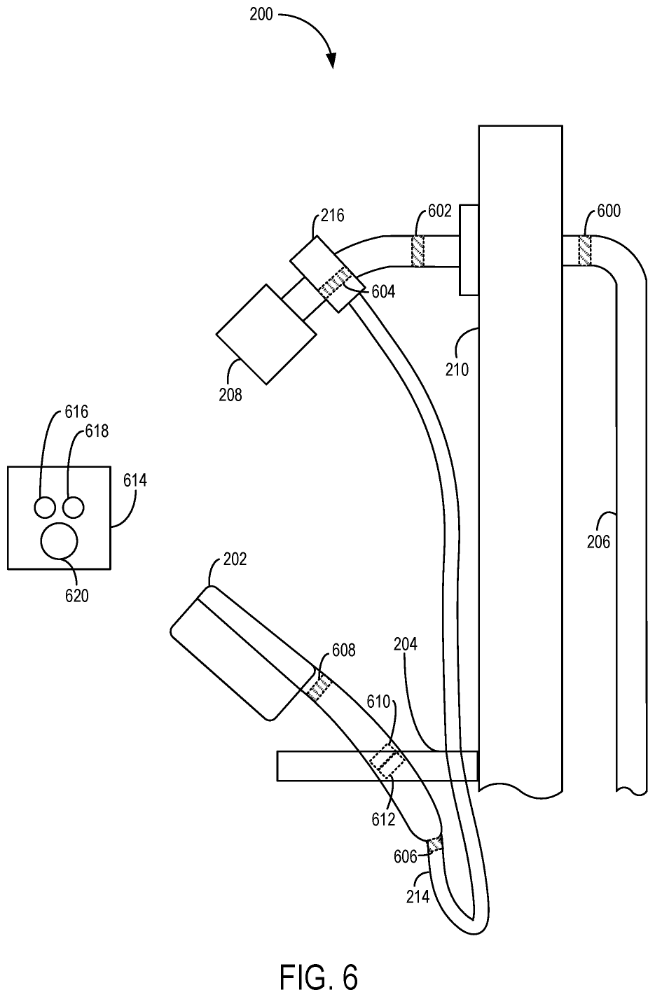

Referring to FIG. 6, an enlarged view of the shower head 202 described above with reference to FIGS. 2-5 is shown. In the view shown by FIG. 6, several portions of the components of the shower system 200 are shaded with hatch shading to indicate locations that may include a shutoff device similar to the shutoff devices described above with reference to FIG. 1. For example, shaded portion 600 indicates a location along the water supply line 206 that may include a shutoff device similar to, or the same as, the shutoff device 130 shown by FIG. 1 and described above. Shaded portion 602 similarly indicates another location along the water supply line 206 that may include a shutoff device similar to, or the same as, the shutoff device 130 shown by FIG. 1 and described above. However, the shaded portion 602 is arranged at a side of the wall 210 including the shower head 202, whereas the shaded portion 600 is arranged at an opposing side of the wall 210 (e.g., an interior side wall 210, away from the shower head 202). Shaded portion 604 indicates yet another location at which the shutoff device may be included (e.g., within the connector 216).

In some embodiments, similar to the examples described above with reference FIG. 1, the shutoff device may be included within the hose 214 coupling the shower head 202 to the water supply line 206 (e.g., at location 606 within the hose 214). In another embodiment, the shutoff device may be located within the shower head 202 (e.g., within a housing or casing of the shower head 202), as indicated by shaded portion 608. Although not shown by FIG. 6, in some embodiments the water supply line may be fluidly coupled to the first mount 204, and the shutoff device may be arranged within the first mount 204. In some embodiments, the shower head 202 may include a first interface device 610 configured to engage with a second interface device 612 of the first mount 204, where the first interface device 610 may be similar to, or the same as, the interface device 114 described above with reference to FIG. 1, and the second interface device 612 may be similar to, or the same as, the interface device 124 described above with reference to FIG. 1. The interface devices may engage with each other in order to engage the shutoff device (e.g., where the shutoff device may be arranged within the shower head 202, as indicated by shaded portion 608, or within the first mount 204, in some embodiments).

FIG. 6 additionally shows a control panel 614 which may be in electronic communication with the shutoff device arranged at one of the locations described above. The control panel 614 may be mounted to a wall of the environment of the shower system 200, in some embodiments. The control panel 614 may include an indicator light 616 indicating a status of the shutoff device (e.g., indicating an engaged or disengaged condition of the shutoff device). Control panel 614 may additionally include one or more knobs or other control devices, such as control device 618, control device 620, etc., to adjust operation of the shower head 202 or other components of the shower system 200. In some embodiments, the control panel 614 may be omitted. The control panel 614 may be combined with any of the described shower systems.

Referring to FIG. 7, a flow chart illustrating a method 700 for controlling a flow rate of water from a shower head of a shower system including a shutoff device is shown. The shower system may be similar to, or the same as, the shower system 100 shown by FIG. 1 and described above, and/or the shower system 200 shown by FIGS. 2-6 and described above. Instructions for carrying out method 700 and the rest of the methods included herein may be executed by an electronic controller of the shower system, in some examples, based on instructions stored on a memory of the controller and in conjunction with signals received from sensors of the shower system, such as the sensors described above with reference to FIG. 1. The controller may employ actuators of the shower system to adjust shower head operation, according to the methods described below. The controller may be integrated with a control panel of the shower system in some embodiments, such as the control panel 134 shown by FIG. 1 and described above, and/or the control panel 614 shown by FIG. 6 and described above. However, in some examples, the method 700 may be performed via mechanically coupling between the various components described herein. For example, engaging the shutoff device, as described herein, may occur as a result of seating of the shower head within the mount, where the shower head includes an interface device configured to engage (e.g., mechanically) with a respective interface device of the mount. The mechanical interaction between the shower head and the mount may thus result in automatic control of the flow of water from the shower head based on the position of the shower head (e.g., whether the shower head is seated within the mount or is unseated from the mount), without electronic or optical communication between the components (e.g., without electronic control of the components via the electronic controller described herein).

At part 702, the method may include estimating and/or measuring shower system operating conditions. Estimating and/or measuring the shower system operating conditions may include determining a condition of the shutoff device of the shower system, determining a position (e.g., orientation) of the shower head via a position sensor of the shower head, determining whether the shower head is seated within a mount similar to, or the same as, the mount 104 and/or the mount 204 via an engagement sensor (e.g., engagement sensor 126 shown by FIG. 1 and described above), etc.

The method continues from part 702 to part 704 where the method includes determining whether the shower head is seated within a mount. The mount may be similar to, or the same as, the mount 104 shown by FIG. 1 and described above, and/or the mount 204 shown by FIGS. 2-6 and described above. In some embodiments, determining whether the shower head is seated within the mount may include determining whether an interface device of the shower head is engaged with an interface device of the mount, in some embodiments (e.g., the interface device of the shower head may be similar to, or the same as, the interface device 114 shown by FIG. 1 and described above, and the interface device of the mount may be similar to, or the same as, the interface device 124 shown by FIG. 1 and described above). In some embodiments, determining whether the shower head is seated within the mount may be based on an output of an engagement sensor of the mount, such as the engagement sensor 126 shown by FIG. 1 and described above.

If the shower head is not seated within the mount at part 704, the method continues from part 704 to part 706 where the method includes determining whether a shower head angle is within a threshold angle range. For example, the shower head angle may be sensed (e.g., measured or detected) by a position sensor within the shower head, and the sensed angle may be compared to a pre-determined angle range, where the pre- determined angle range is defined relative to a vertical direction (e.g., a direction of gravity). In some embodiments, the position sensor may be an electronic position sensor (e.g., a Micro-Electrical-Mechanical System (MEMS) gyroscope), and in other embodiments, the position sensor may be mechanical and may determine the shower head angle in an analog manner.

If the shower head angle is not within the threshold angle range at part 706, the method continues from part 706 to part 714 where the method includes maintaining shower system operating conditions. Maintaining shower system operating conditions may include not adjusting a condition of a shutoff device of the shower system and/or not adjusting a flow rate of water from the shower head.

However, if the shower head is seated within the mount at part 704 or the shower head angle is within the threshold angle range at part 706, the method continues to part 708 where the method includes engaging a shutoff device to maintain a flow rate of water from the shower head below a pre-determined threshold flow rate. The shutoff device may be a valve actuated automatically responsive to the shower system conditions described above, similar to the examples described above with reference to FIGS. 1-6. Maintaining the flow rate of water from the shower head below the pre-determined threshold flow rate may include flowing enough water to the shower head to provide a drip of water from the shower head as described above (e.g., maintaining a temperature of water at the shower head 102 via a low flow rate without spraying the water from the shower head 102), or stopping the flow of water from the shower head altogether (e.g., zero gallons per minute (0 liters per minute) of water flow from the shower head).

Engaging the shutoff device at part 708 may include, at part 710, engaging an interface device of the shower head with an interface device of the mount. The interface device of the shower head may be similar to, or the same as, the interface device 114 described above with reference to FIG. 1, and the interface device of the mount may be similar to, or the same as, the interface device 124 shown by FIG. 1 and described above.

Engaging the shutoff device at part 708 may include, at part 712, transmitting an electronic signal from a communication device disposed within one of the shower head or the mount to the shutoff device. For example, the communication device may be similar to, or the same as, the communication device 120 or the communication device 128 shown by FIG. 1 and described above. The electronic signal transmitted by the communication device may be a wireless electronic signal, in some embodiments. In other embodiments, the communication device may have a direct electrical connection to the shutoff device, and the electronic signal may be transmitted via the direct electrical connection.

In some embodiments, the method 700 may include both of part 704 and part 706, as described above. However, in other embodiments, the method 700 may include part 704 and may not include part 706, or the method 700 may include part 706 and may not include part 704, based on a configuration of the shower system. For example, the shower system may be configured to include the mount but the shower head may not include a position sensor or other device configured to determine the angle of the shower head. In such an example, the method may include part 704 and may not include part 706 (e.g., the method may continue from part 702 to part 704, and from part 704 to part 708 or to part 714). As another example, the shower head of the shower system may include the position sensor or other device configured to determine the angle of the shower head, but the mount may not include the interface device configured to engage with an interface device of the shower head. In such an example, the method may include part 706 and may not include part 704 (e.g., the method may continue from part 702 to part 706, and from part 706 to part 708 or to part 714).

The disclosure also provides support for a shower system, comprising: a shower head, and a shutoff device arranged along a flow path of water to the shower head configured to control a flow of water to the shower head based on a position of the shower head. In a first example of the system, the system further comprises: a mount shaped to receive the shower head, where seating the shower head within the mount actuates the shutoff device to maintain a flow rate of water from the shower head below a pre-determined threshold flow rate. In a second example of the system, optionally including the first example, the shower head includes a first interface device configured to engage with a second interface device of the mount to actuate the shutoff device. In a third example of the system, optionally including one or both of the first and second examples, at least one of the first interface device or the second interface device is a magnet. In a fourth example of the system, optionally including one or more or each of the first through third examples, the shutoff device is housed within the mount. In a fifth example of the system, optionally including one or more or each of the first through fourth examples, the shower head houses the shutoff device and further comprises a position sensor coupled to the shutoff device. In a sixth example of the system, optionally including one or more or each of the first through fifth examples, the position sensor senses an angle of the shower head, and wherein the shutoff device maintains a flow rate of water from the shower head below a pre-determined threshold flow rate while the angle of the shower head is within a pre-determined angle range. In a seventh example of the system, optionally including one or more or each of the first through sixth examples, the pre-determined angle range is relative to a direction of gravity. In an eighth example of the system, optionally including one or more or each of the first through seventh examples, the system further comprises: a communication module housed within the shower head and in electronic communication with the shutoff device, where electronic signals transmitted by the communication module to the shutoff device control an amount of opening of the shutoff device. In a ninth example of the system, optionally including one or more or each of the first through eighth examples, the communication module receives shower head position information from a position sensor housed within the shower head, and controls an amount of opening of the shutoff device via electronic signals transmitted to the shutoff device by the communication module based on the position information. In a tenth example of the system, optionally including one or more or each of the first through ninth examples, the shutoff device is arranged within a hose coupling the shower head to a mount or in-line with a water supply line infrastructure fluidly coupled to the shower head.

The disclosure also provides support for a shower system, comprising: a mount, a shower head shaped to seat within the mount, and a shutoff device engaged by seating the shower head within the mount, where, while engaged, the shutoff device restricts a flow of water from the shower head. In a first example of the system, the shutoff device is integrated with the mount. In a second example of the system, optionally including the first example, the shutoff device is arranged upstream of each of the mount and the shower head. In a third example of the system, optionally including one or both of the first and second examples, the mount includes an engagement sensor in electronic communication with an actuator of the shutoff device and configured to electronically and/or optically sense the seating of the shower head within the mount. In a fourth example of the system, optionally including one or more or each of the first through third examples, the system further comprises: a control panel in electronic communication with the engagement sensor and/or the shutoff device, where, while the shutoff device is engaged, the control panel displays a shutoff indicator.

The disclosure also provides support for a method for a shower system, comprising: controlling a flow rate of water from a shower head based on a position of the shower head by adjusting engagement of a shutoff device automatically responsive to the position of the shower head. In a first example of the method, adjusting engagement of the shutoff device automatically responsive to the position of the shower head includes: engaging an interface device of the shower head with an interface device of a mount by seating the shower head within the mount, and responsive to engaging the interface device of the shower head with the interface device of the mount, engaging the shutoff device to maintain the flow rate of water from the shower head below a pre-determined threshold flow rate. In a second example of the method, optionally including the first example, adjusting engagement of the shutoff device automatically responsive to the position of the shower head includes: determining an angle of the shower head relative to a direction of gravity, and responsive to the angle of the shower head being within a pre-determined angle range, engaging the shutoff device to maintain the flow rate of water from the shower head below a pre-determined threshold flow rate. In a third example of the method, optionally including one or both of the first and second examples, adjusting engagement of the shutoff device automatically responsive to the position of the shower head includes: responsive to seating the shower head within a mount, transmitting an electronic signal from a communication device disposed within one of the shower head or the mount to the shutoff device, and responsive to receiving the electronic signal at the shutoff device, engaging the shutoff device to maintain the flow rate of water from the shower head below a pre-determined threshold flow rate.

FIGS. 2-6 are shown approximately to scale, although other relative dimensions may be used, if desired.

FIGS. 2-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

1. A shower system, comprising:
a shower head; and
a shutoff device arranged along a flow path of water to the shower head configured to control a flow of water to the shower head based on a position of the shower head.

2. The shower system of claim 1, further comprising a mount shaped to receive the shower head, where seating the shower head within the mount actuates the shutoff device to maintain a flow rate of water from the shower head below a pre-determined threshold flow rate.

3. The shower system of claim 2, wherein the shower head includes a first interface device configured to engage with a second interface device of the mount to actuate the shutoff device.

4. The shower system of claim 3, wherein at least one of the first interface device or the second interface device is a magnet.

5. The shower system of claim 2, wherein the shutoff device is housed within the mount.

6. The shower system of claim 1, wherein the shower head houses the shutoff device and further comprises a position sensor coupled to the shutoff device.

7. The shower system of claim 6, wherein the position sensor senses an angle of the shower head, and wherein the shutoff device maintains a flow rate of water from the shower head below a pre-determined threshold flow rate while the angle of the shower head is within a pre-determined angle range.

8. The shower system of claim 7, wherein the pre-determined angle range is relative to a direction of gravity.

9. The shower system of claim 1, further comprising a communication module housed within the shower head and in electronic communication with the shutoff device, where electronic signals transmitted by the communication module to the shutoff device control an amount of opening of the shutoff device.

10. The shower system of claim 9, wherein the communication module receives shower head position information from a position sensor housed within the shower head, and controls an amount of opening of the shutoff device via electronic signals transmitted to the shutoff device by the communication module based on the position information.

11. The shower system of claim 1, wherein the shutoff device is arranged within a hose coupling the shower head to a mount or in-line with a water supply line infrastructure fluidly coupled to the shower head.

12. A shower system, comprising:
a mount;
a shower head shaped to seat within the mount; and
a shutoff device engaged by seating the shower head within the mount, where, while engaged, the shutoff device restricts a flow of water from the shower head.

13. The shower system of claim 12, wherein the shutoff device is integrated with the mount.

14. The shower system of claim 12, wherein the shutoff device is arranged upstream of each of the mount and the shower head.

15. The shower system of claim 12, wherein the mount includes an engagement sensor in electronic communication with an actuator of the shutoff device and configured to electronically and/or optically sense the seating of the shower head within the mount.

16. The shower system of claim 15, further comprising a control panel in electronic communication with the engagement sensor and/or the shutoff device, where, while the shutoff device is engaged, the control panel displays a shutoff indicator.

17. A method for a shower system, comprising:
controlling a flow rate of water from a shower head based on a position of the shower head by adjusting engagement of a shutoff device automatically responsive to the position of the shower head.

18. The method of claim 17, wherein adjusting engagement of the shutoff device automatically responsive to the position of the shower head includes:
engaging an interface device of the shower head with an interface device of a mount by seating the shower head within the mount; and
responsive to engaging the interface device of the shower head with the interface device of the mount, engaging the shutoff device to maintain the flow rate of water from the shower head below a pre-determined threshold flow rate.

19. The method of claim 17, wherein adjusting engagement of the shutoff device automatically responsive to the position of the shower head includes:
determining an angle of the shower head relative to a direction of gravity; and
responsive to the angle of the shower head being within a pre-determined angle range, engaging the shutoff device to maintain the flow rate of water from the shower head below a pre-determined threshold flow rate.

20. The method of claim 17, wherein adjusting engagement of the shutoff device automatically responsive to the position of the shower head includes:
responsive to seating the shower head within a mount, transmitting an electronic signal from a communication device disposed within one of the shower head or the mount to the shutoff device; and
responsive to receiving the electronic signal at the shutoff device, engaging the shutoff device to maintain the flow rate of water from the shower head below a pre- determined threshold flow rate.
